(19) United States
(12) Patent Application Publication
(10) Pub. No.: US 2025/0329144 A1
(43) Pub. Date: Oct. 23, 2025

(54) METHOD FOR SUBDIVIDED REPRESENTATION REINFORCEMENT OF IMAGE/TEXT REPRESENTATION VECTOR THROUGH ATTRIBUTE VALUE OF OBJECT IN IMAGE-LANGUAGE ALIGNMENT MODEL

(71) Applicant: Korea Electronics Technology Institute, Seongnam-si (KR)

(72) Inventors: San KIM, Seongnam-si (KR); Sa Im SHIN, Seoul (KR); Jin Yea JANG, Seongnam-si (KR); Min Young JUNG, Hwaseong-si (KR)

(73) Assignee: Korea Electronics Technology Institute, Seongnam-si (KR)

(21) Appl. No.: 18/873,004

(22) PCT Filed: Oct. 6, 2023
(86) PCT No.: PCT/KR2023/015386

§ 371 Date: Dec. 9, 2024

(30) Foreign Application Priority Data
Nov. 23, 2022 (KR) 10-2022-0157945

(51) Int. Cl. G06V 10/774; G06F 16/53; G06F 16/56; G06V 10/764

(52) U.S. Cl. CPC G06V 10/774; G06F 16/53; G06F 16/56; G06V 10/764

(57) ABSTRACT

A method for subdivided representation reinforcement of an image/text representation vector through an attribute value of an object in an image-language alignment model is provided. The method for training an image-language alignment model, according to an embodiment of the present invention, generates, in an input image, object-specific representation vectors of the image, generates, in an input text, object-specific representation vectors of the text, and uses the generated object-specific representation vectors so as to train an image-language align model through a contrast loss function. Therefore, object-specific attribute representation is reinforced such that each attribute is represented to be subordinate to the objects, and thus accurate image searches can be performed for more complex natural language queries by means of the image-language alignment model, and accurate natural language searches can be performed for images having various objects.

### TECHNICAL FIELD

The disclosure relates to a deep learning technology, and more particularly, to a method for training an image-language alignment model which aligns a representation vector representing an image and a representation vector representing a text.

### BACKGROUND ART

As shown in FIG. 1, a related-art image-language alignment model learns to maximize the inner product between positive pairs and minimize the inner product between negative pairs by using one global representation vector representing all images and one global representation vector representing all texts, thereby aligning embedding vectors of an image model and a language model.

However, images are aligned by using one representation vector and thus it is difficult to clearly represent to which object the attribute of each object in the images is subordinate. For example, related-art methods represent images of FIG. 2 with one representation vector, and, when the inner product between the representation vector of the image and the representation vector of the text “blue shirt and beige pants” is obtained, the inner product of the representation vector of the two images also increases.

To this end, when images on “a jogger in an orange hoodie” are searched in the related-art methods, it is not identified that “orange” is subordinate to the object “hoodie” as in <Top 1> of FIG. 3, and a jogger wearing a “hoodie” and an “orange cap” may be searched.

There have been various attempts to solve this problem, and the most famous one is Contrastive Captions of Google. However, this model is not an object-based representation reinforcement method and does not solve the object attribute subordination problem.

### DISCLOSURE

### Technical Problem

The disclosure has been developed in order to address the above-discussed deficiencies of the prior art, and an object of the disclosure is to provide a method for generating an image-language representation effectively reflecting an object attribute by using an object-specific vector representation, and training an image-language alignment model, as a solution to the problem that a vector representation using only a global representation vector in a contrastive learning-based image-language alignment model does not well reflect an object attribute.

### Technical Solution

According to an embodiment of the disclosure to achieve the above-described object, an image-language alignment model training method may include: a first generation step of generating, by the image-language alignment model, an object representation vector for each object of an image in the inputted image; a second generation step of generating, by the image-language alignment model, an object representation vector for each object of a text in the inputted text; and a step of training the image-language alignment model through a contrastive loss function by using the object representation vector generated at the first generation step and the object representation vector generated at the second generation step.

The object representation vector may be a vector that represents an attribute on an object.

A plurality of attributes may be included for one object.

At the second generation step, the plurality of attributes may be generated by one object representation vector by using mean pooling or attentive pooling.

The image-language alignment model training method according to the disclosure may further include a step of classifying object attributes from the object representation vector generated at the first generation step, and the step of training may include training the image-language alignment model through a cross entropy loss function by using the classified attributes.

The image-language alignment model training method according to the disclosure may further include: a third generation step of generating, by the image-language alignment model, a global representation vector of the image in the inputted image; and a fourth generation step of generating, by the image-language alignment model, a global representation vector of the text in the inputted text, and the step of training may include training the image-language alignment model through a contrastive loss function by using the global representation vector generated at the third generation step and the global representation vector generated at the fourth generation step.

The object may be an object that is detected from the image by an artificial intelligence (AI) model which is trained to detect objects.

The image-language alignment model training method according to the disclosure may further include a step of searching an image based on a text by using the trained image-language alignment model.

The image-language alignment model training method according to the disclosure may further include a step of searching a text based on an image by using the trained image-language alignment model.

According to another aspect of the disclosure, there is provided an image-language alignment model training system including: a processor configured to generate an object representation vector for each object of an image in the image which is inputted to the image-language alignment model, to generate an object representation vector for each object of a text in the text which is inputted to the image-language alignment model, and to train the image-language alignment model through a contrastive loss function by using the generated object representation vectors; and a storage unit configured to provide a storage space necessary for the processor.

According to still another aspect of the disclosure, there is provided an image-language alignment model computation method including: a step of generating an image-language alignment model; and a step of searching an image based on a text by using the generated image-language alignment model, wherein the image-language alignment model is configured to: generate an object representation vector for each object of an image in the image which is inputted to the image-language alignment model; generate an object representation vector for each object of a text in the text which is inputted to the image-language alignment model; and be trained through a contrastive loss function by using the generated object representation vectors.

According to yet another aspect of the disclosure, there is provided an image-language alignment model computation system including: a processor configured to generate an image-language alignment model, and to search an image based on a text by using the generated image-language alignment model; and a storage unit configured to provide a storage space necessary for the processor, wherein the image-language alignment model is configured to: generate an object representation vector for each object of an image in the image which is inputted to the image-language alignment model; generate an object representation vector for each object of a text in the text which is inputted to the image-language alignment model; and be trained through a contrastive loss function by using the generated object representation vectors.

### Advantageous Effects

As described above, according to embodiments of the disclosure, a representation vector is generated for each object existing in an image and a text, and an object attribute representation is reinforced such that each attribute is represented to be subordinate to the objects, and thus accurate image searches can be performed for more complex natural language queries by means of the image-language alignment model, and accurate natural language searches can be performed for an image having various objects.

### DESCRIPTION OF DRAWINGS

FIG. 1 is a view illustrating a related-art image-language alignment model embedding method;

FIG. 2 is a view illustrating images provided to explain problems of the related-art method;

FIG. 3 is a view illustrating results of searching images which are provided to explain problems of the related-art method;

FIG. 4 is a view illustrating the concept of training of Contrastive Captioners;

FIG. 5 is a view illustrating an image-language alignment model training method to which the disclosure is applicable;

FIG. 6 is a view illustrating an image-language alignment model training method according to an embodiment of the disclosure; and

FIG. 7 is a view illustrating an image-language alignment model training/computation system according to another embodiment of the disclosure.

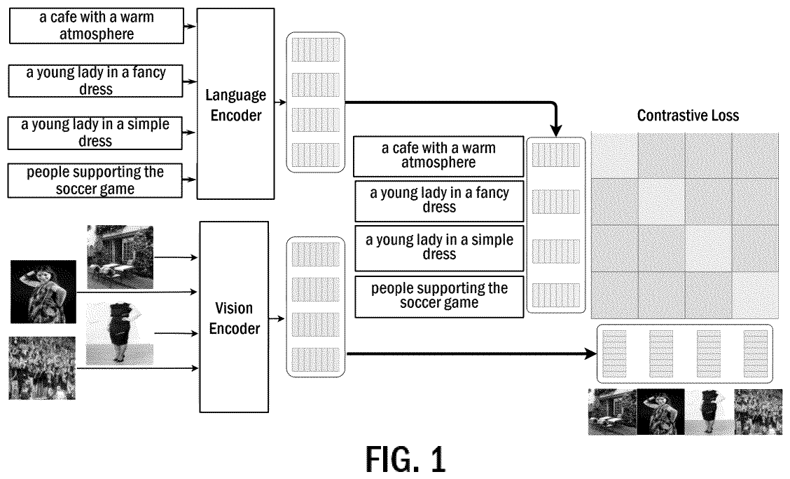

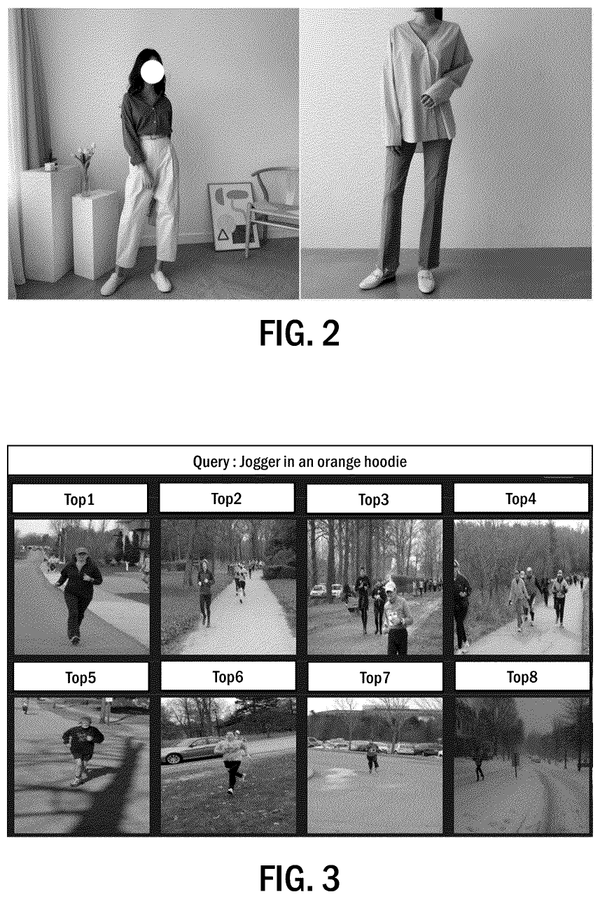

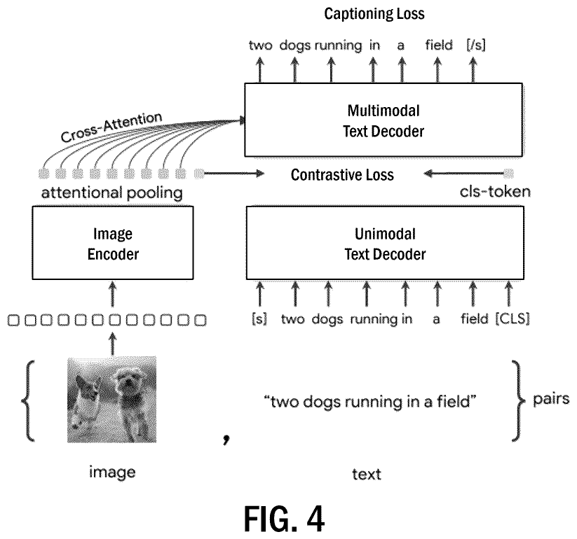

### Best Mode

Hereinafter, the disclosure will be described in more detail with reference to the drawings.

Embodiments of the disclosure propose a method for subdivided representation reinforcement of an image/text representation vector through an attribute value of an object in an image-language alignment model.

The disclosure relates to a technology that enhances performance of searching for complex natural language queries by additionally aligning, in a representation alignment process by the image-language alignment model, object representation vectors within an image and a text, in addition to aligning between global representation vectors, and reinforcing an object attribute representation such that each attribute is represented in the object representation vector through an object attribute classifier.

Specifically, in the image-language model alignment process, the image and the text are divided into combinations of object representation vectors, and object representation vectors are made and object vectors are aligned through a contrastive loss function to increase the inner product between corresponding vectors. In addition, the object attribute representation is reinforced by using an auxiliary loss function such that a corresponding attribute is embedded in the object representation vector by using each object attribute value.

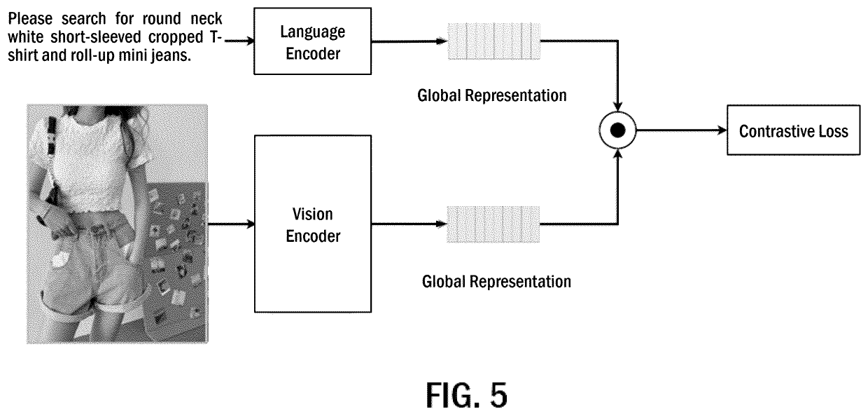

FIG. 5 is a view provided to explain an image-language alignment model training method to which the disclosure is applicable. The trained image-language alignment model is a model that performs only global representation vector alignment.

As shown in the drawing, a text global representation vector is generated in a text inputted to the image-language alignment model, and an image global representation vector is generated in an inputted image, and an inner product between the generated two global representation vectors is obtained, and the image-language alignment model is trained to align corresponding object representation vectors through a contrastive loss function.

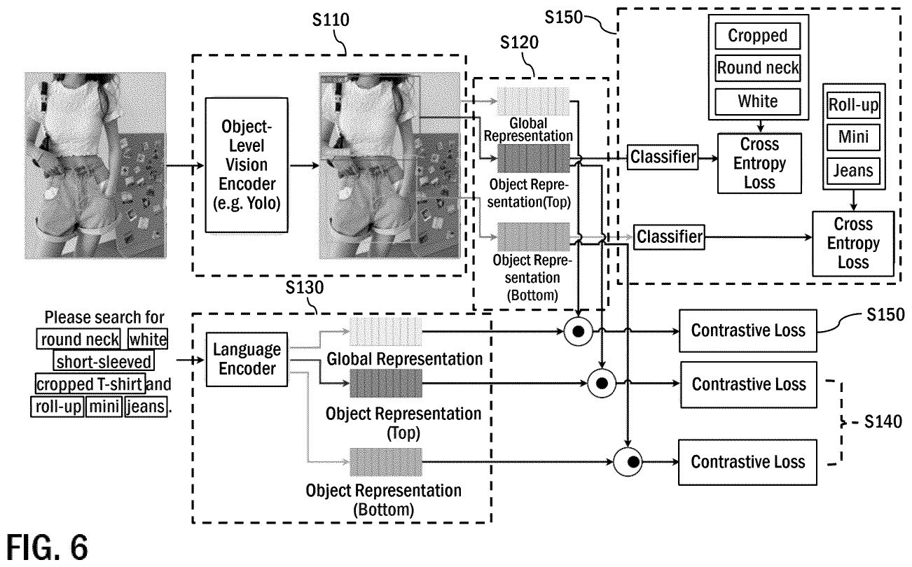

FIG. 6 is a view provided to explain the image-language alignment model training method according to an embodiment of the disclosure. The trained image-language alignment model is a model that aligns object representation vectors in addition to global representation vectors.

An inputted image is inputted to an object detection model, and objects existing in the image are detected (S110). Yolo may be used as the object detection model.

A video encoder of the image-language alignment model generates a global representation vector with respect to the image from which objects are detected, and generates object representation vectors (S120). The number of object representation vectors generated at step S120 may be the same as the number of objects detected from the image.

The object representation vector is a vector that represents an attribute on each object, and one object may include a plurality of attributes.

A text encoder of the image-language alignment model generates a global representation vector on the inputted text, and generates representation vectors on object attribute representation areas (S130).

In FIG. 6, “round neck”, “white”, “short-sleeved”, “cropped T-shirt” are attribute representations on the object <Top>, and at step S130, representations on these areas are represented by one vector and an object representation vector is generated.

Mean pooling, attentive pooling may be used as a method for converting into one object representation.

In FIG. 6, “roll-up”, “mini”, “jeans” are attribute representations on the object <Bottom>, and at step S130, representations on these areas are represented by one vector and an object representation vector is generated.

An inner product between the object representation vector on the image, which is generated at step S120, and the object representation vector on the text, which is generated at step S130, is obtained, and the image-language alignment model is trained to align the corresponding representation vectors through contrastive loss functions (S140).

Attribute values on the object representation vectors on the image are classified by using classifiers, and the image-language alignment model is trained through a cross entropy loss function (S150).

This is to reinforce object attribute representations such that corresponding object attribute values are embedded in the object representation vectors. In FIG. 6, the image-language alignment model is trained to output “cropped”, “round neck”, “white” as classification values in the case of the object representation <Top>, and is trained to output “roll-up”, “mini”, “jeans” as classification values in the case of the object representation <Bottom>.

An inner product between the global representation vector on the image, which is generated at step S120, and the global representation vector on the text, which is generated at step S130, is obtained, and the image-language alignment model is trained to align corresponding representation vectors through the contrastive loss function (S160).

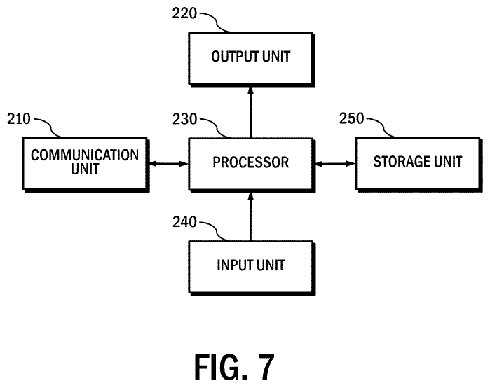

FIG. 7 is a view illustrating a configuration of an image-language alignment model training/computation system according to another embodiment of the disclosure. The image-language alignment model training/computation system according to an embodiment of the disclosure may be implemented by a computing system including a communication unit 210, an output unit 220, a processor 230, an input unit 240, and a storage unit 250 as shown in the drawing.

The communication unit 210 is a communication means for communicating with an external device and connecting to an external network, and the output unit 220 displays a result of executing by the processor 230, and the input unit 240 transmits a user command to the processor 230.

The processor 230 trains the image-language alignment model proposed through FIG. 5, and may search an image based on a text by using the trained image-language alignment model or may search a text based on an image.

The storage unit 250 provides a storage space necessary for functions and operation of the processor 230.

Up to now, the image-language alignment model training method and system have been described in detail with reference to preferred embodiments.

Compared to a related-art method which aligns only a representation vector representing an entire image and a representation vector representing an entire text through a contrastive loss function, the method according to an embodiment of the disclosure aligns not only the global representation vectors but also the object representation vectors of an image/text through the contrastive loss function.

Additionally, the cross entropy loss function for training to classify attribute values is used as an auxiliary loss function in order to embed object attribute representations in object vectors.

Accordingly, representation vectors are generated for objects existing in an image and a text, and object attribute representations are reinforced such that each attribute is represented to be subordinate to the objects, and thus more accurate image searches may be performed in response to complex natural language queries than in a related-art image-language model, and accurate text searches may also be performed in response to an image having various objects.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. An image-language alignment model training method comprising:
a first generation step of generating, by the image-language alignment model, an object representation vector for each object of an image in the inputted image;
a second generation step of generating, by the image-language alignment model, an object representation vector for each object of a text in the inputted text; and
a step of training the image-language alignment model through a contrastive loss function by using the object representation vector generated at the first generation step and the object representation vector generated at the second generation step.

2. The image-language alignment model training method of claim 1, wherein the object representation vector is a vector that represents an attribute on an object.

3. The image-language alignment model training method of claim 2, wherein a plurality of attributes are included for one object.

4. The image-language alignment model training method of claim 3, wherein, at the second generation step, the plurality of attributes are generated by one object representation vector by using mean pooling or attentive pooling.

5. The image-language alignment model training method of claim 1, further comprising a step of classifying object attributes from the object representation vector generated at the first generation step,
wherein the step of training comprises training the image-language alignment model through a cross entropy loss function by using the classified attributes.

6. The image-language alignment model training method of claim 1, further comprising:
a third generation step of generating, by the image-language alignment model, a global representation vector of the image in the inputted image; and
a fourth generation step of generating, by the image-language alignment model, a global representation vector of the text in the inputted text,
wherein the step of training comprises training the image-language alignment model through a contrastive loss function by using the global representation vector generated at the third generation step and the global representation vector generated at the fourth generation step.

7. The image-language alignment model training method of claim 1, wherein the object is an object that is detected from the image by an artificial intelligence (AI) model which is trained to detect objects.

8. The image-language alignment model training method of claim 1, further comprising a step of searching an image based on a text by using the trained image-language alignment model.

9. The image-language alignment model training method of claim 1, further comprising a step of searching a text based on an image by using the trained image-language alignment model.

10. (canceled)

11. An image-language alignment model computation method comprising:
a step of generating an image-language alignment model; and
a step of searching an image based on a text by using the generated image-language alignment model,
wherein the image-language alignment model is configured to:
generate an object representation vector for each object of an image in the image which is inputted to the image-language alignment model;
generate an object representation vector for each object of a text in the text which is inputted to the image-language alignment model; and
be trained through a contrastive loss function by using the generated object representation vectors.

12. An image-language alignment model computation system comprising:
a processor configured to generate an image-language alignment model, and to search an image based on a text by using the generated image-language alignment model; and
a storage unit configured to provide a storage space necessary for the processor,
wherein the image-language alignment model is configured to:
generate an object representation vector for each object of an image in the image which is inputted to the image-language alignment model;
generate an object representation vector for each object of a text in the text which is inputted to the image-language alignment model; and
be trained through a contrastive loss function by using the generated object representation vectors.
